(19) United States
(12) Patent Application Publication
(10) Pub. No.: US 2026/0091809 A1
(43) Pub. Date: Apr. 2, 2026

(54) DETERMINING VEHICLE TRAJECTORIES BASED ON OBJECT BEHAVIORS

(71) Applicant: Zoox, Inc., Foster City, CA (US)

(72) Inventors: Abishek Krishna Akella, San Francisco, CA (US); Yousef Ali Emam, San Francisco, CA (US); Gowtham Garimella, Hayward, CA (US); Anjali Lakshmi Pemmaraju, San Francisco, CA (US)

(21) Appl. No.: 18/899,894

(22) Filed: Sep. 27, 2024

(51) Int. Cl. B60W 60/00; B60W 50/00

(52) U.S. Cl. CPC B60W 60/00274; B60W 50/0097; B60W 2520/14; B60W 2552/53; B60W 2554/4041; B60W 2554/4045; B60W 2554/4046; B60W 2556/10

(57) ABSTRACT

A trajectory associated with a vehicle may be determined based on determining that an object in the vehicle's environment is associated with a behavior of interest which may diverge from a nominal behavior otherwise associated with the object. Based on the divergence from anticipated nominal behavior, a region of the environment may be identified and used to determine a trajectory for control. The determined trajectory may be used to control a vehicle and/or inform the driving behavior of a vehicle.

### BACKGROUND

Autonomous and semi-autonomous vehicles are becoming increasingly prevalent worldwide. These vehicles are equipped with sensor systems and computing devices that enable them to navigate through their environment and make driving decisions. However, the decision-making processes employed by autonomous and semi-autonomous vehicles can sometimes result in behavior that does not sufficiently and/or adequately accommodate the behavior of other object(s) and/or vehicle(s) in the same environment.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 provides an operational example of determining a trajectory for a vehicle when an object in the vehicle's environment is engaged in a parallel parking behavior.

FIG. 2 provides an operational example of determining a trajectory for a vehicle when an object in the vehicle's environment is engaged in a U-turn behavior.

FIG. 3 provides an operational example of determining a trajectory for a vehicle when a pedestrian in the vehicle's environment is detected to be intending to cross a street.

FIG. 4 is a flowchart diagram of an example process for determining whether an object is associated with an irregular behavior.

FIG. 5 is a flowchart diagram of an example process for determining a vehicle trajectory based on whether an object in the vehicle's environment is associated with an irregular behavior.

FIG. 6 depicts a block diagram of an example system for implementing various techniques described herein.

### DETAILED DESCRIPTION

This disclosure describes techniques for determining whether an object in a vehicle's environment is associated with (e.g., was performing in a past period, is currently performing, and/or is predicted to perform in a future period) an irregular behavior and/or determining a trajectory for controlling the vehicle based on whether the object is associated with the irregular behavior. For example, in some cases, an example system may: (i) determine, based on at least one of sensor data associated with the vehicle's environment and/or one or more predicted trajectories associated with the object, that the object is associated with an irregular behavior, (ii) determine an irregular behavior region in the environment based on determining that the object is associated with the regular behavior, and/or (iii) determine the trajectory for controlling the vehicle by penalizing and/or avoiding proximity to and/or intersection with the irregular behavior region.

As used herein, an irregular behavior may refer to an action, maneuver, and/or movement that deviates from the typical and/or expected flow of traffic. A nonlimiting list of examples of irregular behaviors may include one or more of the following: U-turn, three-point turn, parallel parking, backing out (e.g., of a driveway and/or a parking lot), reversing, perpendicular parking, angled parking, double parking, merging (e.g., from a parking, a driveway, a shoulder, and/or the like), driving on the wrong side of the road, abruptly swerving (e.g., to avoid a collision), pulling over (e.g., for an emergency vehicle), crossing (e.g., a street by a pedestrian), a heading misalignment behavior (e.g., where a deviation between a heading associated with an object on a road and a travel direction associated with the road meets or exceeds threshold), a yaw misalignment behavior (e.g., where a change in the yaw of an object over a period of time meets or exceeds a threshold), a negative velocity behavior (e.g., where a velocity associated with a vehicle is negative and/or falls below a threshold, such as a threshold of zero), weaving (e.g., drifting and/or swerving) within a lane and/or between lanes (e.g., due to intoxication or distraction), weaving in and out of traffic, repeatedly crossing a lane boundary, driving in two or more lines simultaneously, rapid acceleration, or rapid deceleration.

In some cases, the system may receive a set of irregular behaviors, where each irregular behavior may be determined based on a set of rules (e.g., condition(s) and/or heuristics). In some cases, the system may determine whether an object is associated with an irregular behavior based on: (i) whether sensor data associated with the object represents that an observed state (e.g., past and/or current state) of the object satisfies a rule associated with the irregular behavior, and/or (ii) whether a predicted trajectory associated with the object represents that a predicted future state of the object satisfies a rule associated with the irregular behavior. In some cases, based on determining that the object is associated with the irregular behavior, the system determines an irregular behavior region in the environment. The irregular behavior region may be a region having one or more geometric features (e.g., a length and/or width), where at least one geometric feature may be determined based on the irregular behavior (e.g., the geometric feature(s) of the irregular behavior region associated with a U-turn behavior may be different from the geometric feature(s) of the irregular behavior region associated with a parallel parking behavior).

In some cases, the techniques described herein include one or more of: (i) determining whether an object is associated with an irregular behavior, (ii) determining an irregular behavior region associated with an object (e.g., an object that is determined to be associated with an irregular behavior), and/or (iii) determining a trajectory for controlling a vehicle based on the irregular behavior region associated with an object in the vehicle's environment. Aspects of these operations are described in greater detail below.

In some cases, the system determines whether an object is associated with an irregular behavior based on: (i) one or more “retrospective” probabilities each representing a likelihood that the object is associated with the irregular behavior at one or more past and/or current times, and/or (ii) one or more “prospective” probabilities each representing a likelihood that the object is associated with the irregular behavior at one or more future times. Accordingly, the system may determine whether an object is associated with an irregular behavior based on a set of retrospective probabilities (e.g., each associated with a past and/or a current time) and a set of prospective probabilities (e.g., each associated with a future time and a predicted trajectory), for example as further described below. A retrospective probability may represent a likelihood that an object is associated with (e.g., is detected to have been performing and/or detected to be performing) an irregular behavior at a past and/or a current time. A prospective probability may represent a likelihood that an object is associated with (e.g., is predicted to be performing) an irregular behavior at a future time and in accordance with a respective predicted object trajectory.

In some cases, given a sequence of T times, including Tₚ past and/or current times and T_{f} future times, and given R predicted trajectories for the object, the system may determine whether the object is associated with an irregular behavior based on: (i) Tₚ retrospective probabilities each representing a likelihood that the object is associated with the irregular behavior at a respective one of the Tₚ past and/or current times, (ii) T_{f}*R prospective probabilities each representing a likelihood that the object is associated with the irregular behavior at a respective one of the T_{f} future times and based on a respective one of the R predicted trajectories, and/or (iii) R trajectory weights each associated with a respective one of the R predicted trajectories. For example, the system may determine whether the object is associated with the irregular behavior based on a total probability that is determined based on: (i) a combination (e.g., a product) of the Tₚ retrospective probabilities associated with the Tₚ past and/or current times, and (ii) a combination (e.g., a sum) of R weighted prospective probabilities each associated with a respective one of the R predicted trajectories. Each weighted prospective probability associated with a respective one of the R predicted trajectories may be determined based on a combination (e.g., a product) of: (i) the trajectory weight associated with the respective predicted trajectory, and (ii) a combination (e.g., a product) of T_{f} prospective probabilities each representing a likelihood that the object is associated with the irregular behavior at a respective one of the T_{f} future times and based on the respective predicted trajectory.

For example, the system may determine whether an object is associated with the irregular behavior based on the equation:

$$p ( b ) = 1 - ( {\prod }_{i = - {T}_{p}}^{0} ( 1 - p ( {b}_{i} ) ) ( {\sum }_{r ∈ R} P ( r ) {\prod }_{j = 1}^{{T}_{f}} ( 1 - p ( {b}_{j} \vert r ) ) ) ) \qquad ( Equation 1 )$$

In Equation 1, (i) p(b) may refer to a total probability (e.g., where b may iterative over a set of B defined irregular behaviors), (ii) p(bi) may refer to a retrospective probability that the object is associated with the regular behavior at an ith past and/or current time (e.g., where i may iterate over Tₚ past and/or current times), (iii) P(r) may represent a trajectory weight for an rth predicted trajectory associated with the object (e.g., where r may range over R predicted trajectories associated with the object), and/or (iv) p(bⱼ|r) may represent a prospective probability that the object is associated with the irregular behavior at a jth future time and in accordance with an rth predicted trajectory associated with the object (e.g., where j may iterate over T_{f} future times and/or where r may iterate over R predicted trajectories associated with the object).

Accordingly, the system may determine whether an object is associated with an irregular behavior based on a total probability associated with the object and the irregular behavior (e.g., the system may determine that the object is associated with the irregular behavior if the total probability exceeds a threshold, and/or the system may determine that the object is not associated with the irregular behavior if the total probability falls below or equals the threshold). In some cases, the system determines the total probability based on a set of predicted trajectories and/or a set of trajectory weights associated with an object. A predicted trajectory may be a trajectory that the object is predicted to follow (e.g., based on one or more observed movements associated with the object, based on a motion model associated with the object, and/or the like). A trajectory weight may represent a degree of confidence in a respective predicted trajectory and/or a likelihood that the respective predicted trajectory represents a future movement of the object. In some cases, the sum of the trajectory weights determined for an object and with respect to a particular prediction time equals a predefined value, such as a predefined value of one. Example techniques for determining a predicted object trajectory and/or a likelihood and/or confidence associated with a predicted object trajectory are described in U.S. Pat. No. 11,169,531, filed on Oct. 4, 2018 and entitled “Trajectory Prediction on Top-Down Scenes,” and in U.S. Pat. No. 10,671,076, filed on Dec. 6, 2017 and entitled “Trajectory Prediction of Third-Party Objects using Temporal Logic And Tree Search,” both of which are incorporated herein by reference in their entireties and for all purposes.

In some cases, a retrospective probability associated with a particular time (e.g., a particular past and/or current time) may be determined based on sensor data (e.g., image data, lidar data, radar data, and/or the like) captured from a vehicle environment in relation to one or more times associated with the particular time. For example, in some cases, a retrospective probability associated with a particular time may be determined based on sensor data associated with a window of time including a defined number of times before the particular time, the particular time, and/or a defined number of times after the particular time. In some cases, to determine a retrospective probability associated with a particular time, the system may: (i) determine an observed state (e.g., a past and/or current observed state) associated with the object at the particular time based on sensor data associated with the particular time, and (ii) determine the retrospective probability based on the observed state. For example, the system may determine the retrospective probability based on: (i) whether the observed state satisfies an irregular behavior rule associated with the irregular behavior, and/or (ii) which of a set of irregular behavior rules associated with the irregular behavior are satisfied by the observed state. An observed state may represent one or more features associated with a pose (e.g., a position and/or orientation) and/or a movement pattern (e.g., velocity, acceleration, jerk, yaw change, heading, and/or the like) of the object as determined based on sensor data associated with that object.

Accordingly, in some cases, the system may determine a retrospective probability associated with a particular time based on sensor data associated with the particular time (e.g., based on a window time before the particular time) and one or more irregular behavior rules associated with a particular irregular behavior. In some cases, the irregular behavior is associated with one or more irregular behaviors. In some of those cases, the system determines that the retrospective probability associated with a particular time has a particular value (e.g., a maximum value, such as a value of one) if the object state associated with the particular time satisfies a threshold number of (e.g., at least one of) the one or more irregular behavior rules. In some cases, the irregular behavior is associated with one or more irregular behaviors each associated with a probability weight, and the system determines the retrospective probability associated with a particular time based on (e.g., based on a sum and/or a highest of) the probability weight(s) associated with a subset of the one or more irregular behaviors satisfied by the particular time's respective object state. For example, an irregular behavior may be associated with a first irregular behavior rule having a probability weight of 0.2, a second irregular behavior rule having a probability weight of 0.5, and a third irregular behavior rule having a probability weight of 0.3. In this example, if the object state associated with a particular time satisfies the first and the second rules but not the first rule, the probability associated with that time may be 0.2+0.5=0.7. Examples of irregular behavior rules are described below.

An irregular behavior rule may be a condition and/or heuristic that: (i) may be satisfied by a state associated with a particular time, and/or (ii) whose satisfaction by a state associated with a particular time may be used to determine a probability that the particular time is associated with a corresponding irregular behavior. For example, an irregular behavior rule associated with a reversing behavior and/or a parallel parking behavior may be satisfied in relation to a particular time if the observed object velocity over a threshold period before the particular time (e.g., over a two-second window before the particular time) falls below a threshold (e.g., a threshold of zero). As another example, another irregular behavior rule associated with a reversing behavior and/or a parallel parking behavior may be satisfied in relation to a particular time if a deviation between the observed object heading over a threshold period before the particular time (e.g., over a two-second window before the particular time) and a travel direction associated with the object's road exceeds a threshold. As another example, an irregular behavior rule associated with a yaw misalignment behavior and/or a U-turn may be satisfied in relation to a particular time if the observed object yaw change (e.g., a change in the object's observed yaw) over a threshold period before the particular time (e.g., over a two-second window before the particular time) exceeds a threshold. As another example, an irregular behavior rule associated with a crossing behavior (e.g., a pedestrian crossing a street) may be satisfied in relation to a particular time if: (i) the difference between the particular time's lateral position and a subsequent time's lateral position exceeds an upper threshold, and (ii) the difference between the particular time's lateral position and a preceding time's lateral position falls below or equals a lower threshold. As another example, an irregular behavior rule associated with a crossing behavior (e.g., a pedestrian crossing a street) may be satisfied in relation to a particular time if a computed intended crossing probability associated with the particular time exceeds a threshold. The intended crossing probability may represent a likelihood that an object (e.g., a pedestrian) is intending to cross a street at the respective time. Example techniques for computing an intended crossing probability associated with a particular time are described below and/or in U.S. patent application Ser. No. 18/621,922, filed on Mar. 29, 2024 and entitled “Machine-Learned Architecture for Efficient Object Attribute and/or Intention Classification,” and in U.S. patent Ser. No. 18/822,164, filed on Aug. 31, 2024 and entitled “Obtaining Parking Zones for Pick Up and Drop Off,” both of which are incorporated by reference herein in their entireties.

In some cases, to determine an intended crossing probability associated with a particular time, the system processes sensor data associated with the particular time (e.g., sensor data associated with the particular time and/or with a window of time before the particular time) using an intended crossing probability model and determines the intended crossing probability based on the model's output. The crossing probability may be a trained machine learning model (e.g., a classification model, such as a multi-class classification model). The model may be configured to determine at least one of the following based on processing the sensor data associated with the particular time: a crossing probability representing a likelihood that the object (e.g., the pedestrian) is crossing a road at the particular time, an intended crossing probability representing a likelihood that the object intends to cross a road at the particular time, an idling likelihood representing a likelihood that the object is idle at the particular time, or a residual likelihood representing a likelihood that the object is not crossing the road, is not intending to cross the road, and/or is not idle at the particular time.

In some cases, the intended crossing probability model is trained using a set of labeled training logs each associated with a respective time. A labeled training log associated with a respective time may include a set of sensor data associated with the respective time (e.g., a window of time before and/or including the respective time) as well as a label associated with the sensor data set (e.g., a label representing whether an object represented by the sensor data is at least one of crossing a road, intending to cross a road, or idle at the respective time). For example, in some cases, the system may determine the label associated with a respective time based on: (i) a difference between a lateral position of the object at the respective time and a lateral position of the object at a subsequent time after the respective time, (ii) a difference between a lateral position of the object at the respective time and a lateral position of the object at a preceding time before the respective time, and (iii) a velocity (e.g., an average velocity) associated with the object at a period including a window of time before, during, and/or after the respective time.

For example, in some cases, the system may label the sensor data set associated with a respective time as intending to cross if: (i) the difference between the respective time's lateral position and the subsequent time's lateral position exceeds an upper threshold, and (ii) the difference between the respective time's lateral position and the preceding time's lateral position falls below or equals a lower threshold. As another example, in some cases, the system may label the sensor data set associated with a respective time as crossing if: (i) the difference between the respective time's lateral position and the subsequent time's lateral position exceeds an upper threshold, and (ii) the difference between the respective time's lateral position and the preceding time's lateral position exceeds a lower threshold. As another example, in some cases, the system may label the sensor data set associated with a respective time as idle if: (i) the difference between the respective time's lateral position and the subsequent time's lateral position falls below or equals an upper threshold, (ii) the difference between the respective time's lateral position and the preceding time's lateral position falls below or equals a lower threshold, and (iii) a velocity (e.g., an average velocity) associated with the respective time falls below a threshold (e.g., a threshold of one). As another example, in some cases, the system may label the sensor data set associated with a respective time as associated with a residual label (e.g., as not crossing, intending to cross, and/or being idle) if: (i) the difference between the respective time's lateral position and the subsequent time's lateral position falls below or equals an upper threshold, (ii) the difference between the respective time's lateral position and the preceding time's lateral position falls below or equals a lower threshold, and (iii) a velocity (e.g., an average velocity) associated with the respective time equals or exceeds a threshold (e.g., a threshold of one). A lateral position may represent a distance between a lateral road boundary and an object position along a lateral axis.

In some cases, to determine a prospective probability associated with a particular future time and a particular predicted object trajectory, the system may: (i) determine a predicted state associated with the object at the particular future time based on the particular predicted trajectory, and (ii) determine the prospective probability based on the predicted state. For example, the system may determine the prospective probability based on: (i) whether the predicted state satisfies an irregular behavior rule associated with the irregular behavior, and/or (ii) which of a set of irregular behavior rules associated with the irregular behavior are satisfied by the predicted state. A predicted state may represent one or more features associated with a pose (e.g., a position and/or orientation) and/or a movement pattern (e.g., velocity, acceleration, jerk, heading, yaw change, and/or the like) of the object if the object were to follow predicted trajectory. For example, the predicted state may represent: (i) a position of an object at a particular future time if the object were to follow a predicted trajectory, (ii) an orientation of an object at a particular future time if the object were to follow a predicted trajectory, and/or (iii) a movement pattern (e.g., velocity, acceleration, jerk, yaw change, heading, and/or the like) of the object at a particular future time if the object were to follow a predicted trajectory.

In some cases, the system is configured to determine an irregular behavior region associated with an object (e.g., an object that is determined to be associated with an irregular behavior). The irregular behavior region may represent a region of the environment that may be associated with a potential risk and/or uncertainty associated with an irregular behavior. In some cases, the irregular behavior region may represent a set of positions that an object is expected to and/or is determined to be likely to traverse while performing the irregular behavior. For example, the irregular behavior region may represent a set of positions that an object is, with at least a threshold probability and/or confidence (e.g., with ninety percent confidence or more), determined to be likely to traverse while performing the irregular behavior. In some cases, an irregular behavior region is an area of environment including (e.g., around, centered at, and/or the like) a current and/or a predicted position of an object that is determined to be associated with an irregular behavior.

In some cases, the system may determine that an object is associated with an irregular behavior if the system determines that a probability of the object being associated with the irregular behavior exceeds a threshold. The probability may, for example, be determined based on a total probability, a retrospective probability, and/or a prospective probability, as described above. In some cases, if the system determines that an object is associated with two or more irregular behaviors, the system may generate two or more irregular behavior regions (e.g., each associated with a respective one of the two or more irregular behaviors). In some cases, if the system generates two or more irregular behavior regions in relation to an object, the system may avoid and/or penalize traversal of and/or proximity to all of the two or more irregular behavior regions. In some cases, the system may penalize traversal of an irregular behavior region associated with an irregular behavior based on a penalization weight, where the penalization weight may be determined based on the probability of the object being associated with the particular irregular behavior.

In some cases, an irregular behavior region is associated with a shape and/or with one or more geometric features (e.g., with one or more of a width, a length, a height, or a radius). In some cases, at least one of the shape or one or more geometric features of an irregular behavior region may be determined based on the corresponding irregular behavior, for example such that the shape and/or geometric feature(s) associated with an irregular behavior region for a first irregular behavior having a first behavior category may be different from the shape and/or geometric feature(s) associated with an irregular behavior region for a second irregular behavior having a second behavior category. For example, in some cases: (i) the irregular behavior region for a parallel parking behavior may be elongated in a longitudinal direction (e.g., the irregular behavior region may be a rectangular region with an elongated dimension in a longitudinal direction), and/or (ii) the irregular behavior region for a U-turn behavior may be elongated in a lateral direction (e.g., the irregular behavior region may be a rectangular region with an elongated dimension in the lateral direction).

In some cases, one or more geometric features of an irregular behavior region may be determined based on a length associated with an object. For example, in some cases, the length of a longitudinal dimension of the irregular behavior region for a parallel parking behavior may be determined based on a length, orientation, and/or velocity associated with the object that is determined to be engaged in the parallel parking behavior (e.g., the longitudinal dimension may be twice a length associated with the object). As another example, in some cases, the length of a lateral dimension of the irregular behavior region for a U-turn behavior may be determined based on a length associated with the object that is determined to be engaged in the parking-turn behavior (e.g., the lateral dimension may be three times a length associated with the object).

In some cases, one or more geometric features of an irregular behavior region may be determined based on a state (e.g., a velocity, an acceleration, and/or the like) associated with the vehicle. In some cases, at least one geometric feature of an irregular behavior region may increase in length as a vehicle's velocity increases. For example, in some cases, (i) if a system determines that an object in a vehicle's environment is associated with an irregular behavior while the vehicle has a first velocity, the system may determine an irregular behavior region having one or more first geometric features (e.g., a height and/or a width), and (ii) if a system determines that an object is associated with the same irregular behavior while the vehicle has a second velocity that is more than the first velocity, the system may determine an irregular behavior region having one or more second geometric features exceeding the one or more first geometric features.

In some cases, the system may determine an irregular behavior region associated with an object based on one or more lanes associated with the object performing the corresponding irregular behavior. For example, in some cases, the system may: (i) determine a region of interest that includes a set of positions that the object is currently traversing and/or is predicted to traverse in a future period (e.g., in the next five seconds) if the object were to perform the corresponding irregular behavior, (ii) determine a set of lanes at least partially covered by the region of interest, and (iii) determine a dimension (e.g., a lateral dimension) of the region of interest to include all of the covered lane(s). In some cases, the region of interest includes, in addition to a first region including the set of positions that the object is currently traversing and/or is predicted to traverse in a future period if the object were to perform the corresponding irregular behavior, a buffer region around the first region. The buffer region may have one or more geometric features (e.g., one or more predefined geometric features, one or more geometric features determined based on one or more geometric features and/or lengths associated with the vehicle and/or the object, one or more geometric features determined based on a state associated with the vehicle, and/or the like). In some cases, one objective behind laterally extending an irregular behavior region to the entirety of the lateral width of a covered lane is to reduce (e.g., avoid, minimize, and/or reduce) in-lane swerving by the vehicle.

In some cases, the system determines an irregular behavior region associated with an object based on a region of interest that includes a set of positions that the object is currently traversing and/or is predicted to traverse in a future period (e.g., in the next five seconds) if the object were to perform the corresponding irregular behavior. For example, the set of positions may include a set of positions that the object is predicted to traverse in the future period with at least a threshold probability and/or confidence. In some cases, the irregular behavior region may include a lateral buffer and/or a longitudinal buffer around the region of interest. The lateral buffer and/or the longitudinal buffer may, for example, be determined based on one or more predefined values, a velocity associated with the vehicle and/or the object, one or more geometric features and/or lengths associated with the vehicle and/or the object, and/or the like.

In some cases, the system determines two or more irregular behavior regions for an object across two or more future times. For example, in some cases, the system may determine: (i) a first irregular behavior region associated with a first future time (e.g., a first point in time and/or a first time interval in the future) based on a set of points that the object is predicted to traverse at the first future time if performing an irregular behavior, and (ii) a second irregular behavior region associated with a second future time (e.g., a second point in time and/or a second time interval in the future) based on a set of points that the object is predicted to traverse at the second future time if performing the irregular behavior. In some cases, both of the irregular behavior regions may be used to determine a trajectory for controlling the vehicle. For example, the vehicle's trajectory may be determined based on: (i) a first cost determined based on a proximity and/or an intersection measure associated with the trajectory at the first future time and the first irregular behavior region, and (ii) a second cost determined based on a proximity and/or an intersection measure associated with the trajectory at the second time and the second irregular behavior region.

In some cases, the system is configured to determine a trajectory for controlling a vehicle based on an irregular behavior region in the vehicle's environment. In some cases, the system may determine the vehicle trajectory by avoiding and/or penalizing traversal of the irregular behavior region. In some cases, the system may determine the trajectory based on a set of costs associated with a set of candidate trajectories. The cost for a trajectory may be determined based on a proximity and/or intersection of the trajectory and the irregular behavior region. Example techniques for determining a trajectory for controlling a vehicle based on cost(s) associated with one or more trajectories (e.g., one or more candidate trajectories) are described in U.S. Pat. No. 11,360,477, filed on Jun. 22, 2020 and entitled “Trajectory Generation using Temporal Logic and Tree Search,” in U.S. Pat. No. 10,671,076, filed on Dec. 6, 2017 and entitled “Trajectory Prediction of Third-Party Objects using Temporal Logic and Tree Search,” and in U.S. patent application Ser. No. 18/679,987, entitled “Determining Adversarial Cost Based on Generated Deviations” and filed on May 31, 2024, all of which are incorporated by reference in their entirety and for all purposes.

In some cases, the system determines a cost associated with a trajectory based on a proximity and/or intersection measure associated with the trajectory and an irregular behavior region. A proximity measure associated with a trajectory may represent a degree of proximity between a pose (e.g., a position and/or orientation) associated with a trajectory and a pose associated with an irregular behavior region (e.g., the closest pose in the irregular behavior region to the trajectory position(s), a centroid pose of the irregular behavior region, and/or the like). For example, in some cases, the system may: (i) identify one or more poses associated with the trajectory (e.g., over a defined period such as over a five-second period), (ii) for each of the identified pose(s), determine a distance between the identified pose(s) and a pose associated with the irregular behavior region (e.g., a closest pose in the irregular behavior region to the trajectory position(s), a centroid pose of the irregular behavior region, and/or the like), and (iii) determine the proximity measure associated with the trajectory based on the determined distance(s) (e.g., based on a sum of the distance(s), based on a minimum of the distance(s), and/or the like). As another example, in some cases, the system may: (i) identify a pose associated with the trajectory and a particular time, (iii) identify an irregular behavior region associated with the particular time, (iii) determine a distance between the identified pose and a pose associated with the identified irregular behavior region, and (iii) determine the proximity measure associated with the trajectory based on the determined distance.

An intersection measure associated with a trajectory may represent a degree of intersection between pose(s) associated with the trajectory and the irregular behavior region. For example, in some cases, the system may: (i) identify one or more poses associated with the trajectory (e.g., over a defined period such as over a five-second period), (ii) for each of the identified pose(s), determine whether the identified pose intersects the irregular behavior region, and (iii) determine the intersection measure associated with the trajectory based on the pose(s) determined to intersect the irregular behavior region (e.g., based on a number and/or ratio of the pose(s) determined to intersect the irregular behavior region). As another example, in some cases, the system may: (i) identify a pose associated with the trajectory and a particular time, (ii) identify an irregular behavior region associated with the particular time, (iii) determine whether the identified pose intersects the identified irregular behavior region, and (iv) determine the intersection measure associated with the trajectory based on whether the identified pose intersects the identified irregular behavior region.

In some cases, the system determines a cost associated with a trajectory based on a combination (e.g., a weighted combination) of a proximity measure and an intersection measure. For example, the system may determine the cost based on a weighted sum of the proximity measure and the intersection measure. In some cases, the system determines a set of costs each associated with a respective one of a set of candidate trajectories and selects a trajectory from the set of candidate trajectories based on the determined cost(s). For example, the system may select the trajectory associated with the lowest cost in the set of determined costs.

In some cases, the system controls the vehicle based on the selected trajectory. For example, the system may control one or more of a steering system, a throttle system, or a braking system of the vehicle to follow the selected trajectory. In some cases, the system controls the vehicle to follow the selected trajectory by: (i) determining one or more vehicle control parameters based on the selected trajectory (e.g., determining a steering angle based on a lateral motion profile of the selected trajectory, determining a throttle position based on a longitudinal acceleration profile of the selected trajectory, determining a braking pressure based on a deceleration represented by the longitudinal acceleration profile of the selected trajectory, and/or the like), and (ii) controlling one or more of the steering system, the throttle system, or the braking system of the vehicle based on the determined vehicle control parameter(s).

In some cases, the system updates the irregular behavior region and/or the selected trajectory as the vehicle moves through the environment. For example, the system may receive updated sensor data (e.g., at a defined interval, such as every one hundred milliseconds) and determine an updated irregular behavior region and/or an updated selected trajectory based on the updated sensor data. In some cases, the system controls the vehicle based on the updated irregular behavior region and/or the updated selected trajectory (e.g., by controlling one or more of the steering system, the throttle system, or the braking system of the vehicle based on the updated irregular behavior region and/or the updated selected trajectory).

In some cases, the techniques discussed herein may enhance the safety of passengers in a vehicle and/or other individuals in proximity to the vehicle. For example, by determining whether an object in the vehicle's environment is associated with an irregular behavior and controlling the vehicle based on the determination, the techniques described herein may reduce the likelihood of the vehicle colliding with the object and/or otherwise enhance the safety of the vehicle's passengers and/or other individuals in proximity to the vehicle. In some cases, if the system determines that an object in the vehicle's environment is associated with an irregular behavior (e.g., a pedestrian is predicted to cross the road unexpectedly), the system may control the vehicle to slow down, stop, and/or otherwise maneuver to reduce the likelihood of colliding with the object.

Furthermore, by determining a trajectory for controlling the vehicle based on the irregular behavior region (e.g., by penalizing and/or avoiding trajectories that traverse the irregular behavior region), the techniques described herein may enable the vehicle to navigate the environment in a safer and/or more efficient manner. For example, by selecting a trajectory that avoids an irregular behavior region associated with a pedestrian who is predicted to cross the road unexpectedly, the techniques described herein may enable the vehicle to reduce the likelihood of colliding with the pedestrian while still making progress towards its destination.

In some cases, the techniques described herein may also enhance the safety of passengers in a vehicle and/or other individuals in proximity to the vehicle by enabling the vehicle to respond to changes in its environment in a timely and/or appropriate manner. For example, by updating the irregular behavior region and/or the selected trajectory as the vehicle moves through the environment (e.g., based on updated sensor data), the techniques described herein may enable the vehicle to adapt its behavior to changes in the environment (e.g., changes in the behavior of objects in the environment) and/or to maintain a safe and/or efficient trajectory as the vehicle progresses through the environment.

In some cases, the techniques described herein may increase the computational efficiency of vehicle trajectory determination. For example, in some cases, the system may reduce the computational complexity of vehicle trajectory determination by rejecting any trajectory whose proximity measure and/or intersection measure with respect to an irregular behavior region exceeds a threshold. By rejecting such trajectories early in the trajectory determination process, the system may avoid the need to perform more computationally expensive operations (e.g., collision checking, cost calculation, and/or the like) on those trajectories, which may reduce the overall computational burden of the trajectory determination process. Additionally, by focusing the trajectory determination process on trajectories that are less likely to be impacted by irregular behavior regions, the techniques described herein may enable the system to identify a safe and/or efficient trajectory more quickly and/or with fewer computational resources. Accordingly, in some cases, the techniques described herein may increase the computational speed and/or real-time responsiveness of vehicle trajectory determination.

The methods, apparatuses, and systems described herein may be implemented in a number of ways. Example implementations are provided below with reference to the following figures. Although discussed in the context of an autonomous vehicle, in some examples, the methods, apparatuses, and systems described herein may be applied to a variety of systems. In another example, the methods, apparatuses, and systems may be utilized in an aviation or nautical context. Additionally, or alternatively, the techniques described herein may be used with real data (e.g., captured using sensor(s)), simulated data (e.g., generated by a simulator), or any combination thereof.

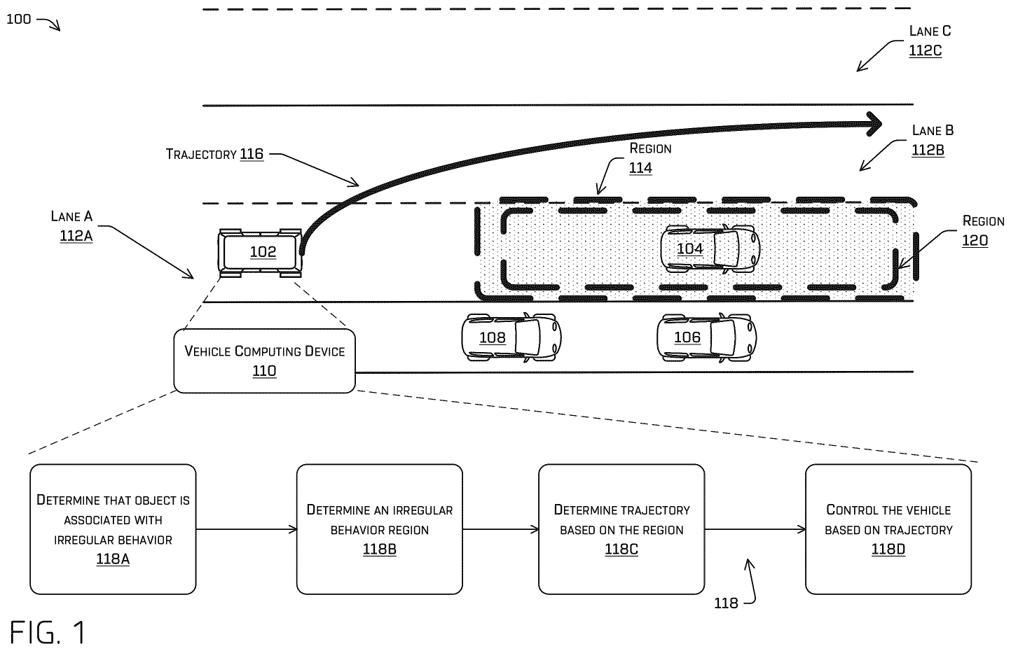

FIG. 1 provides an operational example 100 of determining a trajectory 116 for a vehicle 102 when an object 104 in the vehicle's environment is engaged in a parallel parking behavior to park between object 106 and object 108. The operational example 100 depicts a road with three lanes: lane A 112A, lane B 112B, and lane C 112C. The vehicle 102 and the object 104 are both in lane A 112A, which is the leftmost lane.

The operational example 100 illustrates that a vehicle computing device 110 associated with the vehicle may respond to the depicted scenario by performing the process 118. As depicted in FIG. 1, at operation 118A, the vehicle computing device 110 determines that the object 104 is associated with an irregular behavior, specifically the parallel parking behavior. This determination may be based on the observed state(s) (e.g., the observed behavior(s)) of the object 104 and/or the predicted future trajectory of the object 104. Example techniques for determining whether an object is associated with an irregular behavior are described above.

At operation 118B, the vehicle computing device 110 determines an irregular behavior region 114 based on detecting that the object 104 is associated with an irregular behavior. In some cases, the irregular behavior region 114 is a region of the environment that includes (e.g., centered at, around, and/or the like) a detected and/or predicted pose (e.g., position) of the object 104. In some cases, the irregular behavior region 114 is elongated in the longitudinal direction, for example based on determining that the corresponding irregular behavior is a parallel parking behavior. In some cases, the irregular behavior region 114 includes the area around a detected and/or predicted position of the object 104 where the parallel parking behavior is expected to affect and/or occur. Example techniques for determining irregular behavior regions are described above.

In some cases, determining an irregular behavior region is based on: (i) determining a region of interest that includes an area around a detected and/or predicted position of the object that the object is expected to traverse when performing the irregular behavior, and (ii) extending the region of interest in the lateral direction to laterally cover each lane associated with the region of interest. The region of interest may include: (i) a target region around a detected and/or predicted position of the object that the object is expected to traverse when performing the irregular behavior, and (ii) a “buffer region” around the target region. Example techniques for determining an irregular behavior region based on a buffer region are described above.

For example, as depicted in FIG. 1, to determine the irregular behavior region 114, the vehicle computing device 110 may: (i) determine that the parallel parking behavior is expected to affect the region of interest 120, (ii) determine that the region of interest 120 includes portions of lane A 112A, and (iii) laterally extend the region of interest 120 to cover the entirety of the lane A 112A. The region of interest 120 may, for example, include: (i) a target region around a detected and/or predicted position of the object 104 that the object 104 is expected to traverse when performing the irregular behavior, and (ii) a “buffer region” around the target region. In some cases, one objective behind laterally extending an irregular behavior region 114 to the entirety of the lateral width of a covered lane is to reduce (e.g., avoid, minimize, and/or reduce) in-lane swerving by the vehicle 102.

At operation 118C, the vehicle computing device 110 determines a trajectory 116 for controlling the vehicle 102 based on the irregular behavior region 114. In some cases, the trajectory 116 is determined such that it reduces (e.g., avoids, minimizes, penalizes, and/or the like) proximity to and/or intersection with the irregular behavior region 114. In some cases, the vehicle computing device 110 determines the trajectory 116 by avoiding and/or penalizing proximity to and/or intersection with the irregular behavior region 114. Example techniques for determining a trajectory based on an irregular behavior region are described above.

For example, as depicted in FIG. 1, the trajectory 116 involves the vehicle 102 shifting from lane A 112A to lane C 112C to maintain a safe distance from the object 104 and the irregular behavior region 114 associated with the detected parallel parking behavior by the object 104. In some cases, one objective behind this lane shift is to reduce swerving by the vehicle 102 within the lane A 112A, which is the lane currently occupied by the vehicle 102 and/or the object 104.

At operation 118D, the vehicle computing device 110 controls the vehicle 102 based on the trajectory 116. In some cases, the vehicle computing device 110 controls the vehicle 102 to follow the trajectory 116, for example by generating and sending control signals to various vehicle systems, such as the steering, throttle, and/or braking systems. These control signals may cause the vehicle 102 to execute the maneuvers necessary to track the trajectory 116 and/or safely navigate the vehicle 102 around the irregular behavior region 114 and/or the object 104. For example, to initiate the lane change from lane A 112A to lane C 112C, the vehicle computing device 110 may send signals to the steering system to turn the wheels and guide the vehicle 102 into lane C 112C. Additionally or alternatively (e.g., simultaneously), the vehicle computing device 110 may adjust the throttle and/or braking of the vehicle 102 to maintain an appropriate speed during the lane change maneuver.

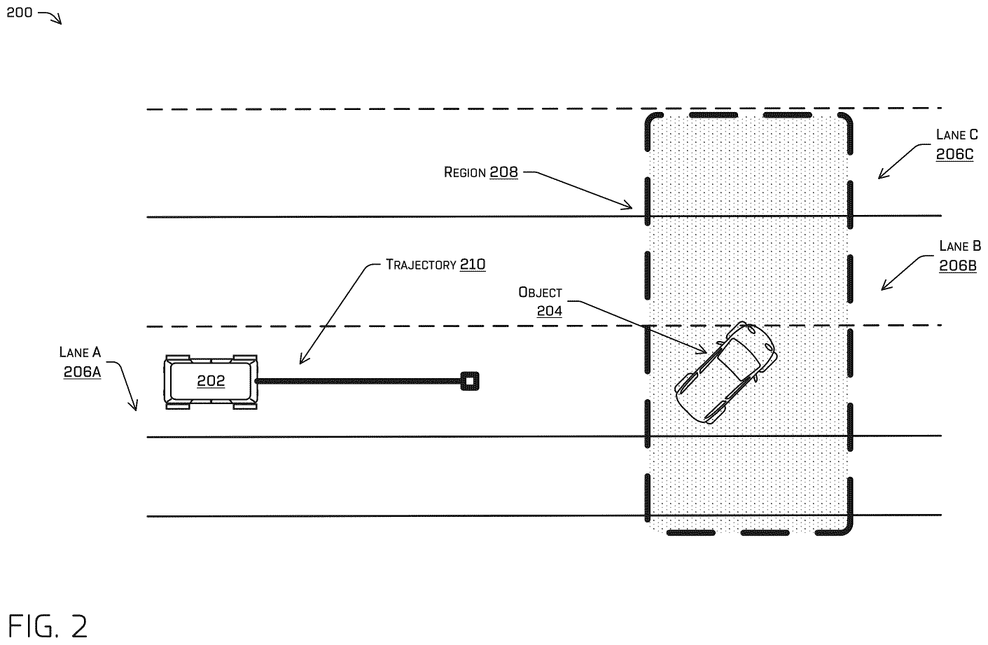

FIG. 2 provides an operational example 200 of determining a trajectory 210 for a vehicle 202 when an object 204 in the vehicle's environment is engaged in a U-turn behavior. The operational example 200 depicts a road with three lanes: lane A 206A, lane B 206B, and lane C 206C. The vehicle 202 is traveling in lane A 206A, which is the leftmost lane. The object 204 is also initially positioned in lane A 206A.

As depicted in FIG. 2, to determine the trajectory 210, a system (e.g., a vehicle computing device, a remote server device communicating with the vehicle device, and/or the like) may determine an irregular behavior region 208. To determine the irregular behavior region 208, the system may determine that the object 204 is associated with a U-turn behavior and determine the irregular behavior region 208 based on determining that the object 204 is associated with the U-turn behavior. Example techniques for determining whether an object is associated with a U-turn behavior and/or for determining an irregular behavior region associated with a U-turn behavior are described below.

In some cases, the irregular behavior region 208 includes an area that the object 204 is expected to traverse during the U-turn behavior. This area may be determined based on an anticipated path of the U-turn behavior by the object 204. For example, as depicted in FIG. 2, the irregular behavior region 208 extends from lane A 206A, where the object 204 is initially located, into lane B 206B and lane C 206C. This may be based on determining that the anticipated path of a U-turn behavior by the object 104 is expected to traverse both lane B 206B and lane C 206C.

After determining the irregular behavior region 208, the vehicle computing device may determine a trajectory 210 for the vehicle 202 based on the irregular behavior region 208. For example, the vehicle computing device may determine the trajectory by avoiding and/or penalizing traversal of the irregular behavior region 208. Example techniques for determining a trajectory based on an irregular behavior region are described above.

For example, as depicted in FIG. 2, the trajectory 210 includes stopping before the irregular behavior region 208. This may be because the vehicle computing device determines that it may be impossible to avoid traversing the irregular behavior region 208 while traveling on a permitted lane. In some cases, the trajectory 210 includes slowing down along the longitudinal direction.

After determining the trajectory 210, the vehicle computing device may control the vehicle 202 based on the trajectory 210. This may involve sending control signals to various vehicle systems, such as the steering, throttle, and/or braking systems, to execute the maneuvers necessary to follow the trajectory 210 and/or safely navigate the vehicle 202 based on the irregular behavior region 208 and/or the object 204. For example, in FIG. 2, the vehicle computing device may control the vehicle 202 to slow down and/or come to a stop before reaching the irregular behavior region 208. This may involve sending signals to the throttle system to reduce the vehicle's speed and/or to the braking system to apply the brakes to bring the vehicle 102 to a stop.

In some cases, while the vehicle 202 is stopped, the vehicle computing device may monitor the state(s) (e.g., behavior(s)) of the object 204. After detecting that the object 204 has completed the U-turn, the vehicle computing device may determine that it is safe for the vehicle 202 to resume its forward journey. The vehicle computing device may then generate an updated trajectory that involves accelerating from the stopped position and continuing forward in lane A 206A.

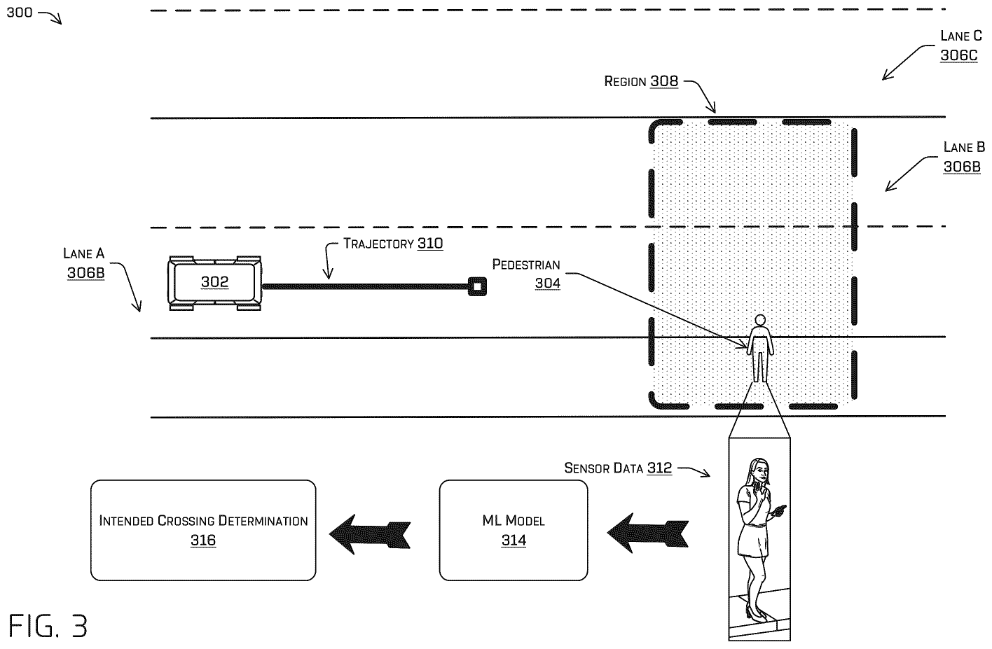

FIG. 3 provides an operational example 300 of determining a trajectory 310 for a vehicle 302 when a pedestrian 304 in the vehicle's environment is detected to be intending to cross a street. The operational example 300 depicts a road with three lanes: lane A 306A, lane B 306B, and lane C 306C. The vehicle 302 is traveling in lane B 306B, which is the middle lane. The pedestrian 304 is positioned on the sidewalk adjacent to lane A 306A.

As depicted in FIG. 3, a system (e.g., a vehicle computing device, a remote server device communicating with the vehicle device, and/or the like) receives sensor data 312 associated with the pedestrian 304. The sensor data 312 may represent the pedestrian's position, movement pattern (e.g., speed, direction of movement, and/or the like), body language, and/or the like. In some cases, the sensor data 312 includes one or more sensor data frames (e.g., one or more image frames, one or more lidar frames such as one or more lidar point clouds, one or more radar frames such as one or more radar point clouds, and/or the like). Example techniques for determining whether an object is intending to cross a street based on sensor data associated with the object are described above.

As further depicted in FIG. 3, the system processes the sensor data 312 using a machine learning model 314 to determine an intended crossing determination 316. The intended crossing determination 316 may represent a determination that the pedestrian 304 is intended to cross the street. For example, the intended crossing determination 316 may represent that an intended cross probability generated by the machine learning model 314 and based on processing the sensor data 312 exceeds a threshold. The machine learning model 314 may be an intended crossing prediction model, as further described above. Example techniques for training and/or performing a predictive inference using an intended crossing model are described above.

In some cases, if the intended crossing determination 316 represents that the pedestrian 304 is expected to cross the street, the system determines an irregular behavior region 308 around the pedestrian 304. The irregular behavior region 308 may represent the area of the road that the pedestrian 304 is likely to traverse while performing the crossing behavior. For example, the irregular behavior region 308 may include an area that the pedestrian is likely to traverse if the pedestrian were to perform the crossing behavior and before the vehicle 302 is expected to cross an area that is laterally aligned with the pedestrian's current and/or expected pose (e.g., position).

In some cases, the irregular behavior region 308 is determined based on at least one of an expected velocity of the vehicle 302, an expected velocity of the pedestrian 304, an expected position of the vehicle 302 at a future time, or an expected position of the pedestrian 304 at a future time. For example, the system may: (i) determine an expected position of the vehicle 302 at a future time, (ii) determine an expected position of the pedestrian 304 at the same future time, (iii) determine a proximity measure based on the two expected positions, and/or (iv) based on determining that the proximity measure exceeds a threshold, include at least one of the expected positions in the irregular behavior region 308. As another example, the system may: (i) determine an expected position of the vehicle 302 at a future time, (ii) determine an expected position of the pedestrian 304 at the same future time, (iii) determine that the two expected positions are in the same lane, and/or (iv) based on determining that the two expected positions are in the same lane, include a lateral width of that lane in the irregular behavior region 308.

After determining the irregular behavior region 308, the system determines a trajectory 310 for the vehicle 302 based on the irregular behavior region 308. The system may determine trajectory by avoiding and/or penalizing proximity to and/or intersection with the irregular behavior region 308 to reduce the risk of a collision with the pedestrian 304 crossing the street. For example, as depicted in FIG. 1, the trajectory 310 includes the vehicle 302 stopping before the irregular behavior region 308.

After determining the trajectory 310, the vehicle 302 may be controlled based on the trajectory 310. This may involve sending control signals to the vehicle's steering, throttle, and/or braking systems to execute the lane change maneuver and/or to adjust the vehicle's speed as needed to accommodate the pedestrian's crossing of the street.

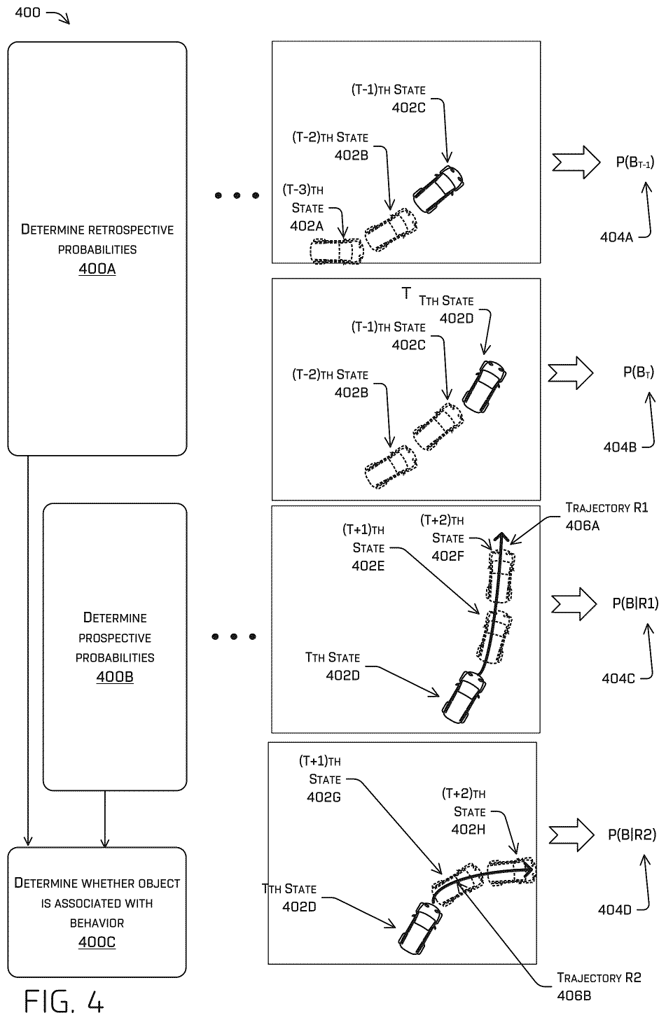

FIG. 4 is a flowchart diagram of an example process 400 for determining whether an object is associated with an irregular behavior. As depicted in FIG. 4, at operation 400A, a system (e.g., a vehicle computing device, a remote server device communicating with the vehicle device, and/or the like) determines one or more retrospective probabilities associated with an object performing the irregular behavior. A retrospective probability may represent a likelihood that an object performs an irregular behavior based on sensor data associated with one or more past and/or current times. Example techniques for determining retrospective probabilities (e.g., based on past and/or current object states) are described above.

In some cases, the system determines a retrospective probability based on one or more past and/or current states associated with the object. A state may represent an estimated pose (e.g., position and/or orientation) and/or an estimated movement pattern associated with the object at a respective time. In some cases, to determine to retrospective probability associated with a particular time (e.g., a past and/or a current time), the system: (i) receives the states associated with a window of time before the particular time, and (ii) processes the states (e.g., in accordance with one or more rules for determining irregular behavior) to determine the retrospective probability.

For example, as depicted in FIG. 4, the system determines P (Bₜ₋₁) 404A, which may be the retrospective probability associated with the (t−1)th time, based on: (i) the observed object state 402A associated with the (t−3)th time, (ii) the observed object state 402B associated with the (t−2)th time, and (iii) the observed object state 402C associated with the (t−1)th time. As another example, as depicted in FIG. 4, the system determines P(Bₜ) 404B, which may be the retrospective probability associated with the ith time, based on: (i) the observed object state 402B associated with the (t−2)th time, (ii) the observed object state 402C associated with the (t−1)th time, and (iii) the observed object state 402D associated with the ith time. Accordingly, with respect to each of both the ith time and the (t−1)th time, the system determines the corresponding retrospective probability based on the respective time's state and the states associated with two preceding times.

At operation 400B, the system determines one or more prospective probabilities associated with the object performing the irregular behavior. A prospective probability may represent a likelihood that an object performs an irregular behavior at a future time if the object follows a predicted trajectory. Example techniques for determining prospective probabilities (e.g., based on predicted object states represented by predicted object trajectories) are described above.

In some cases, the system determines a prospective probability based on one or more predicted object states represented by a predicted trajectories associated with the object. Accordingly, in some cases, the system determines R prospective probabilities each associated with one of R predicted trajectories for the object and based on one or more predicted object states represented by the respective predicted object trajectory.

For example, as depicted in FIG. 4, the system determines P (B|R1) 404C, which may be the prospective probability associated with the predicted trajectory R1 406A, based on: (i) the state 402D associated with the Ith time, (ii) the predicted state 402E associated with the (t+1)th time if the object were to follow the predicted trajectory R1 406A, and (iii) the predicted state 402F associated with the (t+2)th time if the object were to follow the predicted trajectory R1 406A. As another example, as depicted in FIG. 4, the system determines P (B|R2) 404D, which may be the prospective probability associated with the predicted trajectory R2 406B, based on: (i) the state 402D associated with the ith time, (ii) the predicted state 402G associated with the (t+1)th time if the object were to follow the predicted trajectory R2 406B, and (iii) the predicted state 402H associated with the (t+2)th time if the object were to follow the predicted trajectory R2 406B.

At operation 400C, the system determines whether the object is associated with the irregular behavior based on the one or more retrospective probabilities and the one or more prospective probabilities. For example, the system may determine whether the object is associated with the irregular behavior based on: (i) a combination (e.g., a product) of the one or more retrospective probabilities, and (ii) a combination (e.g., a product) of a set of weighted prospective probabilities each determined by combining (e.g., multiplying) one of the prospective probabilities with a probability weight associated with the respective predicted trajectory. Example technique for whether an object is associated with the irregular behavior based on one or more retrospective probabilities and/or one or more prospective probabilities are described above, for example in relation to Equation 1 presented above.

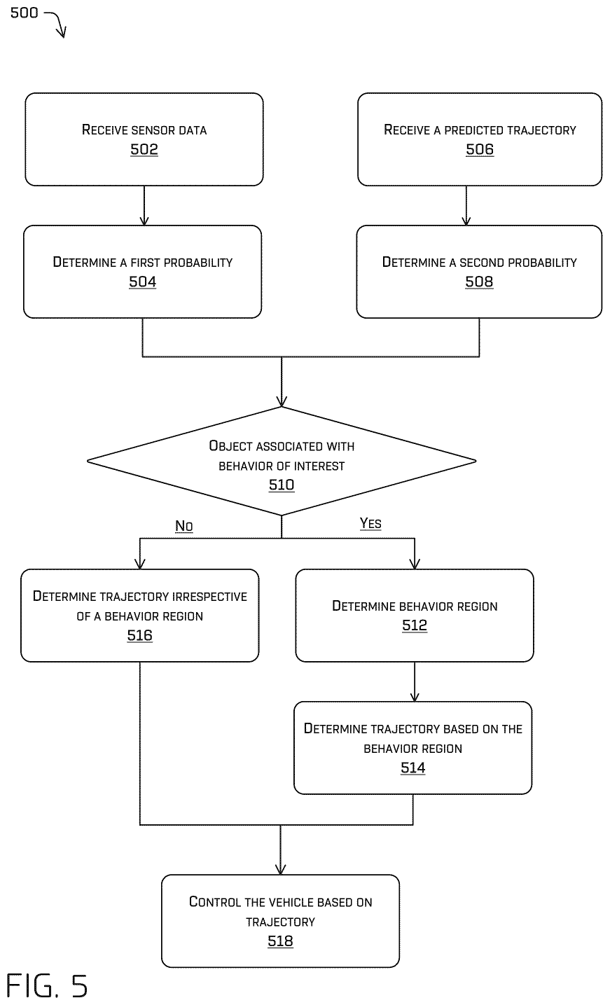

FIG. 5 is a flowchart diagram of an example process 500 for determining a vehicle trajectory based on whether an object in the vehicle's environment is associated with an irregular behavior. As depicted in FIG. 5, at operation 502, a system (e.g., a vehicle computing device, a remote server device communicating with the vehicle device, and/or the like) receives sensor data associated with the vehicle environment. The sensor data may represent pose(s) and/or movement pattern(s) associated with the object. The sensor data may, for example, include image data, sensor data, lidar data, and/or the like.

At operation 504, the system determines a first probability associated with whether an object in the vehicle's environment is associated with the irregular behavior based on the received sensor data. This first probability may represent a retrospective probability associated with a past and/or current time. Example techniques for determining retrospective probabilities based on sensor data are described above.

At operation 506, the system receives a predicted trajectory associated with the object. The predicted trajectory may represent a prediction about a lateral and/or longitudinal movement of the object over a future period. The predicted trajectory may be associated with a probability and/or confidence score, which may be used to determine a trajectory weight associated with the predicted trajectory. Example techniques for determining predicted object trajectories and/or corresponding trajectory weights are described above.

At operation 508, the system determines a second probability associated with whether the object is associated with the irregular behavior based on the received predicted trajectory. This second probability may represent a prospective probability associated with a future time and the predicted trajectories. Example techniques for determining prospective probabilities based on predicted object trajectories are described above.

At operation 510, the system determines whether the object is associated with the irregular behavior based on the first probability and the second probability. For example, the system may determine whether the object is associated with the irregular behavior based on: (i) the output of combining the first probability and/or one or more other retrospective probabilities, and/or (ii) the output of combining one or more weighted prospective probabilities. One of those weighted prospective probabilities may be determined based on the output of combining the received predicted trajectory and a corresponding trajectory weight. Example technique for whether an object is associated with the irregular behavior based on one or more retrospective probabilities and/or one or more prospective probabilities are described above, for example in relation to Equation 1 presented above.

If the system determines that the object is associated with an irregular behavior (operation 510—Yes), the system proceeds to operation 512 to determine an irregular behavior region associated with the object based on determining that the object is associated with an irregular behavior. The irregular behavior region may represent an area of the environment that may be affected by the object if the object were to follow the irregular behavior. Example techniques for determining irregular behavior regions are described above.

At operation 514, the system determines a trajectory for controlling the vehicle based on the determined irregular behavior region. In some cases, the system determines a trajectory by avoiding and/or penalizing proximity to and/or intersection with the irregular behavior region. For example, the system may set a cost associated with proximity and/or intersection of a candidate trajectory to the irregular behavior region to a value determined based on that proximity and/or intersection measure. Example techniques for determining a trajectory based on an irregular behavior region are described above.

If the system determines that the object is not associated with the irregular behavior (operation 510—No), the system proceeds to operation 516 to determine a trajectory irrespective of the irregular behavior region. For example, the system may set a cost associated with proximity and/or intersection of a candidate trajectory to the irregular behavior region to a minimal value, such as a value of zero.

At operation 518, the system controls the vehicle based on the determined trajectory. In some cases, the system controls the vehicle to follow the trajectory, for example by generating and sending control signals to various vehicle systems, such as the steering, throttle, and/or braking systems. Example techniques for controlling a vehicle based on a trajectory are described above.

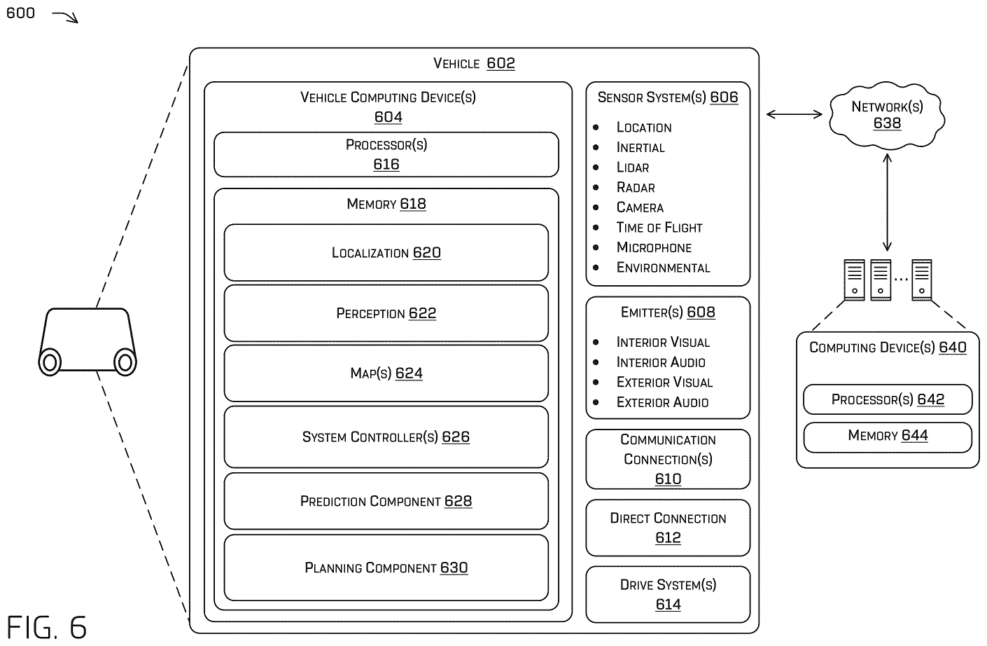

FIG. 6 depicts a block diagram of an example system 600 for implementing various techniques described herein. In some instances, the example system 600 may include vehicle 602 and one or more computing devices 640. In some instances, the vehicle 602 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 602 may be a fully or partially autonomous vehicle having any other level or classification. Moreover, in some instances, the techniques described herein may be usable by non-autonomous vehicles as well. These are merely examples, and the systems and methods described herein also may be incorporated into any ground-borne, airborne, or waterborne vehicle, including those ranging from vehicles that need to be manually controlled by a driver at all times, to those that are partially or fully autonomously controlled.

The vehicle 602 may include vehicle computing device(s) 604, sensor(s) 606, emitter(s) 608, network interface(s) 610, at least one direct connection 612 (e.g., for physically coupling with the vehicle to exchange data and/or to provide power), and one or more drive system(s) 614. The system 600 may additionally or alternatively comprise vehicle computing device(s) 604.

In some instances, the sensor(s) 606 may include lidar sensors, radar sensors, ultrasonic transducers, sonar sensors, location sensors (e.g., global positioning system (GPS), compass,), inertial sensors (e.g., inertial measurement units (IMUs), accelerometers, magnetometers, gyroscopes,), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors,), etc.

The vehicle 602 may also include emitter(s) 608 for emitting light and/or sound, as described above. The vehicle 602 may also include network interface(s) 610 that enable communication between the vehicle 602 and one or more other local or remote computing device(s). The network interface(s) 610 may include physical and/or logical interfaces for connecting the vehicle computing device(s) 604 to another computing device or a network, such as network(s) 638.

In some instances, the vehicle 602 may include one or more drive system(s) 614 (or drive components). In some instances, the vehicle 602 may have a single drive system 614. In some instances, the drive system(s) 614 may include one or more sensors to detect conditions of the drive system(s) 614 and/or the surroundings of the vehicle 602. By way of example and not limitation, the sensor(s) of the drive system(s) 614 may include one or more wheel encoders (e.g., rotary encoders) to sense rotation of the wheels of the drive components, inertial sensors (e.g., inertial measurement units, accelerometers, gyroscopes, magnetometers) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive system(s) 614. In some cases, the sensor(s) on the drive system(s) 614 may overlap or supplement corresponding systems of the vehicle 602 (e.g., sensor(s) 606).

The drive system(s) 614 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.).

The vehicle computing device(s) 604 may include processor(s) 616 and memory 618 communicatively coupled with the one or more processors 616. Computing device(s) 640 may also include processor(s) 642, and/or memory 644.

The processor(s) 616 and/or 642 may be any suitable processor capable of executing instructions (e.g., computer-executable instructions) to process data and perform operations as described herein. By way of example and not limitation, the processor(s) 616 and/or 642 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 618 and/or 644 may be examples of non-transitory computer-readable media. Memory 618 and/or 644 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, memory 618 and/or memory 644 may store a localization component 620, perception component 622, maps 624, system controller(s) 626, prediction component 628, and/or planning component 630.

In at least one example, the localization component 620 may include hardware and/or software to receive data from the sensor(s) 606 to determine a position, velocity, and/or orientation of the vehicle 602 (e.g., one or more of an x-, y-, z-position, roll, pitch, or yaw).

Memory 618 may further include one or more maps 624 that may be used by the vehicle 602 to navigate within the environment. For the purpose of this discussion, a map may be any number of data structures modeled in two dimensions, three dimensions, or N-dimensions that may provide information about an environment, such as, but not limited to, topologies (such as intersections), streets, mountain ranges, roads, terrain, and the environment in general. In one example, a map may include a three-dimensional mesh generated using the techniques discussed herein. In some instances, the map may be stored in a tiled format, such that individual tiles of the map represent a discrete portion of an environment and may be loaded into working memory as needed. In at least one example, the one or more maps 624 may include at least one map (e.g., images and/or a mesh) generated in accordance with the techniques discussed herein. In some examples, the vehicle 602 may be controlled based at least in part on the maps 624. That is, the maps 624 may be used in connection with the localization component 620, the perception component 622, and/or the planning component 630 to determine a location of the vehicle 602, identify objects in an environment, and/or generate routes and/or trajectories to navigate within an environment.

In some instances, the perception component 622 may comprise a primary perception system and/or a prediction system implemented in hardware and/or software. In some examples, sensor data and/or perception data may be used to generate an environment state that represents a current state of the environment. For example, the environment state may be a data structure that identifies object data (e.g., object position, area of environment occupied by object, object heading, object velocity, historical object data), environment layout data (e.g., a map or sensor-generated layout of the environment), environment condition data (e.g., the location and/or area associated with environmental features, such as standing water or ice, whether it's raining, visibility metric), sensor data (e.g., an image, point cloud), etc. In some examples, the environment state may include a top-down two-dimensional representation of the environment and/or a three-dimensional representation of the environment, either of which may be augmented with object data. In yet another example, the environment state may include sensor data alone. In yet another example, the environment state may include sensor data and perception data together.

Prediction component 628 may include functionality to generate predicted information associated with objects in an environment.

Planning component 630 may receive a location and/or orientation of the vehicle 602 from the localization component 620, perception data from the perception component 622, and/or predicted trajectories from the prediction component 628 and may determine instructions for controlling operation of the vehicle 602 based at least in part on any of this data.

Memory 618 and/or 644 may additionally or alternatively store a mapping system (e.g., generating a map based at least in part on sensor data), a planning system, a ride management system, etc. Although localization component 620, perception component 622, the prediction component 628, the planning component 630, and/or system controller(s) 626 are illustrated as being stored in memory 618, any of these components may include processor-executable instructions, machine-learned model(s) (e.g., a neural network), and/or hardware and all or part of any of these components may be stored on memory 644 or configured as part of computing device(s) 640.

As described herein, the localization component 620, the perception component 622, the prediction component 628, the planning component 630, and/or other components of the system 600 may comprise one or more ML models. For example, the localization component 620, the perception component 622, the prediction component 628, and/or the planning component 630 may each comprise different ML model pipelines. The prediction component 628 may use a different ML model or a combination of different ML models in different circumstances. For example, the prediction component 628 may use different GNNs, RNNs, CNNs, MLPs and/or other neural networks tailored to outputting predicted object trajectories in different seasons (e.g., summer or winter), different driving conditions and/or visibility conditions (e.g., times when border lines between road lanes may not be clear or may be covered by snow), and/or based on different crowd or traffic conditions (e.g., more conservative trajectories in a crowded traffic conditions such as downtown areas, etc.). In various examples, any or all the above ML models may comprise an attention mechanism, GNN, and/or any other neural network. An exemplary neural network is a biologically inspired algorithm which passes input data through a series of connected layers to produce an output. Each layer in a neural network may also comprise another neural network or may comprise any number of layers (whether convolutional or not). As may be understood in the context of this disclosure, a neural network may utilize machine-learning, which may refer to a broad class of such algorithms in which an output is generated based on learned parameters.

Although discussed in the context of neural networks, any type of machine-learning may be used consistent with this disclosure. For example, machine-learning algorithms may include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), clastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-60, ResNet-101, VGG, DenseNet, PointNet, and the like.

Memory 618 may additionally or alternatively store one or more system controller(s) 626, which may be configured to control steering, propulsion, braking, safety, emitters, communication, and other systems of the vehicle 602. These system controller(s) 626 may communicate with and/or control corresponding systems of the drive system(s) 614 and/or other components of the vehicle 602.

In an additional or alternate example, vehicle 602 and/or computing device(s) 640 may communicate (e.g., transmit and/or receive messages over network(s) 638) with one or more passenger devices (not shown). A passenger device may include, for example, a smart phone, portable computer such as a laptop or tablet, wearable device (e.g., smart glasses, smart watch, earpiece), and/or the like. Although a passenger device may be a device associated with a passenger that is discrete from device(s) of the autonomous vehicle, it is contemplated that the passenger device may be a sub-system and/or a device of the vehicle 602. For example, the passenger device may additionally or alternatively comprise a display and/or one or more input/output devices, such as a touchscreen, microphone, speaker, and/or the like. In some examples, the vehicle 602 may transmit messages and/or receive messages from the passenger device.

It should be noted that while FIG. 6 is illustrated as a distributed system, in alternative examples, components of the vehicle 602 may be associated with the computing device(s) 640 and/or components of the computing device(s) 640 may be associated with the vehicle 602. That is, the vehicle 602 may perform one or more of the functions associated with the computing device(s) 640, and vice versa.

### CONCLUSION

While one or more examples of the techniques described herein have been described, various alterations, additions, permutations, and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples. For example, the components and instructions of FIG. 6 may utilize the processes and flows of FIGS. 1-4.

A non-limiting list of objects may include obstacles in an environment, including but not limited to pedestrians, animals, cyclists, trucks, motorcycles, other vehicles, or the like. Such objects in the environment have a “geometric pose” (which may also be referred to herein as merely “pose”) comprising a location and/or orientation of the overall object relative to a frame of reference. In some examples, pose may be indicative of a position of an object (e.g., pedestrian), an orientation of the object, or relative appendage positions of the object. Geometric pose may be described in two-dimensions (e.g., using an x-y coordinate system) or three-dimensions (e.g., using an x-y-z or polar coordinate system), and may include an orientation (e.g., roll, pitch, and/or yaw) of the object. Some objects, such as pedestrians and animals, also have what is referred to herein as “appearance pose.” Appearance pose comprises a shape and/or positioning of parts of a body (e.g., appendages, head, torso, eyes, hands, feet, etc.). As used herein, the term “pose” refers to both the “geometric pose” of an object relative to a frame of reference and, in the case of pedestrians, animals, and other objects capable of changing shape and/or positioning of parts of a body, “appearance pose.” In some examples, the frame of reference is described with reference to a two- or three-dimensional coordinate system or map that describes the location of objects relative to a vehicle. However, in other examples, other frames of reference may be used.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

### Example Clauses

While the example clauses described below are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

A: A system comprising: one or more processors; and one or more non-transitory computer-readable media storing computer-executable instructions that, when executed, cause the system to perform operations comprising: receiving sensor data associated with an environment of a vehicle; determining, based at least in part on the sensor data, a first state associated with an object in the environment, the first state being associated with at least one of a past time or a current time and representing at least one of a first position or a first orientation; receiving a predicted trajectory associated with the object, the predicted trajectory representing a second state associated with a future time and being associated with a trajectory weight, the second state representing at least one of a second position or a second orientation; determining, based at least in part on the first state, a first probability associated with the object performing a behavior of interest; determining, based at least in part on the second state and the trajectory weight, a second probability associated with the object performing the behavior of interest; determining, based at least in part on the first probability and the second probability, that the object is associated with the behavior of interest; determining, based at least in part on determining that the object is performing the behavior of interest, a region of the environment having a geometric feature; determining a trajectory based at least in part on the region; and controlling the vehicle based on the region.

B: The system of paragraph A, wherein determining the first probability is based on at least one of: a difference associated with a first heading represented by the first state and a second heading associated with the environment; a velocity represented by the first state; a yaw change represented by the first state; or a predicted movement associated with the object.

C: The system of paragraph A or B, wherein determining that the object is associated with the behavior of interest comprises: determining, based on a third state represented by a second predicted trajectory and a second trajectory weight associated with the second predicted trajectory, a third probability associated with the object performing the behavior of interest; and determining that the object is associated with the behavior of interest based on the first probability, the second probability, and the third probability.

D: The system of any of paragraphs A-C, wherein determining the region comprises: determining the geometric feature based on a lane associated with the object and a buffer length; and determining the region based on the geometric feature.

E: The system of any of paragraphs A-D, wherein the behavior of interest is associated with at least one of: a U-turn behavior, a parallel parking behavior, a reversing behavior, a yaw misalignment behavior, a heading misalignment behavior, or a negative velocity behavior.

F: One or more non-transitory computer-readable media storing instructions executable by one or more processors, wherein the instructions, when executed, cause the one or more processors to perform operations comprising: determining, based at least in part on sensor data associated with an environment of a vehicle, a probability that an object in the environment is performing a behavior of interest; determining, based at least in part on determining that the object is performing the behavior of interest, a region of the environment having a geometric feature, wherein the geometric feature is determined based on the behavior of interest; determining, based at least in part on the region, a trajectory for controlling the vehicle; and controlling the vehicle based at least in part on the trajectory.

G: The one or more non-transitory computer-readable media of paragraph F, wherein determining the region comprise at least one of: determining a longitudinal length associated with the region based at least in part on whether the behavior of interest comprises a parallel parking maneuver; or determining a lateral length associated with the region based at least in part on whether the behavior of interest comprises a U-turn maneuver.

H: The one or more non-transitory computer-readable media of paragraph F or G, wherein determining the region comprises: determining the geometric feature based on a lane associated with the object and a buffer length; and determining the region based on the geometric feature.

I: The one or more non-transitory computer-readable media of any of paragraphs F-H, wherein determining the geometric feature is based on the probability, a velocity associated with the vehicle, and a buffer length.

J: The one or more non-transitory computer-readable media of any of paragraphs F-I, wherein determining the probability is based on whether a difference associated with a first heading and a second heading exceeds a threshold, the first heading being represented by the sensor data and the second heading being associated with the environment.

K: The one or more non-transitory computer-readable media of any of paragraphs F-J, wherein determining the probability is based on whether a velocity represented by the sensor data is negative.

L: The one or more non-transitory computer-readable media of any of paragraphs F-K, wherein determining the probability is based on whether a yaw change represented by the sensor data meets or exceeds a threshold.

M: The one or more non-transitory computer-readable media of any of paragraphs F-L, wherein determining the probability is based on: a first value determined based on a first combination of a set of probabilities associated with at least one of one or more past times or one or more current times; and a second value determined based on a second combination of a set of weighted probabilities associated with a set of future times, one of the set of weighted probabilities determined based on a predicted movement pattern represented by a predicted trajectory associated with the object and a trajectory weight associated with the predicted trajectory.

N: The one or more non-transitory computer-readable media of any of paragraphs F-M, wherein controlling the vehicle comprises: determining a cost associated with the trajectory based on a proximity measure associated with the region and trajectory; and controlling the vehicle based at least in part on the cost.

O: A method comprising: determining, based on sensor data associated with an environment of a vehicle, a probability that an object in the environment is performing a behavior of interest; determining, based on determining that the object is performing the behavior of interest, a region of the environment having a geometric feature, wherein the geometric feature is determined based on the behavior of interest; determining, based at least in part on the region, a trajectory for controlling the vehicle; and controlling the vehicle based at least in part on the trajectory.

P: The method of paragraph O, wherein determining the region comprise at least one of: determining a longitudinal length associated with the region based at least in part on whether the behavior of interest comprises a parallel parking maneuver; or determining a lateral length associated with the region based at least in part on whether the behavior of interest comprises a U-turn maneuver.

Q: The method of paragraph O or P, wherein determining the region comprises: determining the geometric feature based on a lane associated with the object and a buffer length; and determining the region based on the geometric feature.

R: The method of any of paragraphs O-Q, wherein determining the geometric feature is based on the probability, a velocity associated with the vehicle, and a buffer length.

S: The method of any of paragraphs O-R, wherein determining the probability is based on whether a difference associated with a first heading and a second heading exceeds a threshold, the first heading being represented by the sensor data and the second heading being associated with the environment.

T: The method of any of paragraphs O-S, wherein determining the probability is based on whether a velocity represented by the sensor data is negative.

What is claimed is:

1. A system comprising:
one or more processors; and
one or more non-transitory computer-readable media storing computer-executable instructions that, when executed, cause the system to perform operations comprising:
receiving sensor data associated with an environment of a vehicle;
determining, based at least in part on the sensor data, a first state associated with an object in the environment, the first state being associated with at least one of a past time or a current time and representing at least one of a first position or a first orientation;
receiving a predicted trajectory associated with the object, the predicted trajectory representing a second state associated with a future time and being associated with a trajectory weight, the second state representing at least one of a second position or a second orientation;
determining, based at least in part on the first state, a first probability associated with the object performing a behavior of interest;
determining, based at least in part on the second state and the trajectory weight, a second probability associated with the object performing the behavior of interest;
determining, based at least in part on the first probability and the second probability, that the object is associated with the behavior of interest;
determining, based at least in part on determining that the object is performing the behavior of interest, a region of the environment having a geometric feature;
determining a trajectory based at least in part on the region; and
controlling the vehicle based on the region.

2. The system of claim 1, wherein determining the first probability is based on at least one of:
a difference associated with a first heading represented by the first state and a second heading associated with the environment;
a velocity represented by the first state;
a yaw change represented by the first state; or
a predicted movement associated with the object.

3. The system of claim 1, wherein determining that the object is associated with the behavior of interest comprises:
determining, based on a third state represented by a second predicted trajectory and a second trajectory weight associated with the second predicted trajectory, a third probability associated with the object performing the behavior of interest; and
determining that the object is associated with the behavior of interest based on the first probability, the second probability, and the third probability.

4. The system of claim 1, wherein determining the region comprises:
determining the geometric feature based on a lane associated with the object and a buffer length; and
determining the region based on the geometric feature.

5. The system of claim 1, wherein the behavior of interest is associated with at least one of:
a U-turn behavior,
a parallel parking behavior,
a reversing behavior,
a yaw misalignment behavior,
a heading misalignment behavior, or
a negative velocity behavior.

6. One or more non-transitory computer-readable media storing instructions executable by one or more processors, wherein the instructions, when executed, cause the one or more processors to perform operations comprising:
determining, based at least in part on sensor data associated with an environment of a vehicle, a probability that an object in the environment is performing a behavior of interest;
determining, based at least in part on determining that the object is performing the behavior of interest, a region of the environment having a geometric feature, wherein the geometric feature is determined based on the behavior of interest;
determining, based at least in part on the region, a trajectory for controlling the vehicle; and
controlling the vehicle based at least in part on the trajectory.

7. The one or more non-transitory computer-readable media of claim 6, wherein determining the region comprise at least one of:
determining a longitudinal length associated with the region based at least in part on whether the behavior of interest comprises a parallel parking maneuver; or
determining a lateral length associated with the region based at least in part on whether the behavior of interest comprises a U-turn maneuver.

8. The one or more non-transitory computer-readable media of claim 6, wherein determining the region comprises:
determining the geometric feature based on a lane associated with the object and a buffer length; and
determining the region based on the geometric feature.

9. The one or more non-transitory computer-readable media of claim 6, wherein determining the geometric feature is based on the probability, a velocity associated with the vehicle, and a buffer length.

10. The one or more non-transitory computer-readable media of claim 6, wherein determining the probability is based on whether a difference associated with a first heading and a second heading exceeds a threshold, the first heading being represented by the sensor data and the second heading being associated with the environment.

11. The one or more non-transitory computer-readable media of claim 6, wherein determining the probability is based on whether a velocity represented by the sensor data is negative.

12. The one or more non-transitory computer-readable media of claim 6, wherein determining the probability is based on whether a yaw change represented by the sensor data meets or exceeds a threshold.

13. The one or more non-transitory computer-readable media of claim 6, wherein determining the probability is based on:
a first value determined based on a first combination of a set of probabilities associated with at least one of one or more past times or one or more current times; and
a second value determined based on a second combination of a set of weighted probabilities associated with a set of future times, one of the set of weighted probabilities determined based on a predicted movement pattern represented by a predicted trajectory associated with the object and a trajectory weight associated with the predicted trajectory.

14. The one or more non-transitory computer-readable media of claim 6, wherein controlling the vehicle comprises:
determining a cost associated with the trajectory based on a proximity measure associated with the region and trajectory; and
controlling the vehicle based at least in part on the cost.

15. A method comprising:
determining, based on sensor data associated with an environment of a vehicle, a probability that an object in the environment is performing a behavior of interest;
determining, based on determining that the object is performing the behavior of interest, a region of the environment having a geometric feature, wherein the geometric feature is determined based on the behavior of interest;
determining, based at least in part on the region, a trajectory for controlling the vehicle; and
controlling the vehicle based at least in part on the trajectory.

16. The method of claim 15, wherein determining the region comprise at least one of:
determining a longitudinal length associated with the region based at least in part on whether the behavior of interest comprises a parallel parking maneuver; or
determining a lateral length associated with the region based at least in part on whether the behavior of interest comprises a U-turn maneuver.

17. The method of claim 15, wherein determining the region comprises:
determining the geometric feature based on a lane associated with the object and a buffer length; and
determining the region based on the geometric feature.

18. The method of claim 15, wherein determining the geometric feature is based on the probability, a velocity associated with the vehicle, and a buffer length.

19. The method of claim 15, wherein determining the probability is based on whether a difference associated with a first heading and a second heading exceeds a threshold, the first heading being represented by the sensor data and the second heading being associated with the environment.

20. The method of claim 15, wherein determining the probability is based on whether a velocity represented by the sensor data is negative.
